(19) United States
(12) Patent Application Publication
(10) Pub. No.: US 2020/0157983 A1
(43) Pub. Date: May 21, 2020

(54) ELECTRIC OIL PUMP SYSTEM AND CONTROLLING METHOD OF ELECTRIC OIL PUMP

(71) Applicant: TOYOTA JIDOSHA KABUSHIKI KAISHA, Toyota-shi (JP)

(72) Inventor: Yu HIRAI, Toyota-shi (JP)

(73) Assignee: TOYOTA JIDOSHA KABUSHIKI KAISHA, Toyota-shi (JP)

(21) Appl. No.: 16/677,782

(22) Filed: Nov. 8, 2019

(30) Foreign Application Priority Data
Nov. 19, 2018 (JP) 2018-216874

(51) Int. Cl. F01M 1/02; B60S 5/00; F04B 51/00

(52) U.S. Cl. CPC F01M 1/02; B60S 5/00; F04B 2207/043; F01M 2001/0215; F04B 2201/12; F04B 51/00

(57) ABSTRACT

It is provided an electric oil pump system and a controlling method of an electric oil pump. The electric oil pump system includes an electric oil pump and an electronic control unit. The electronic control unit is configured to accumulate driving time of the electric oil pump, predict driving time of the electric oil pump that will occur in the future, and determine degradation of the electric oil pump by taking into account an accumulated driving time and a predicted driving time.

### CROSS-REFERENCE TO RELATED APPLICATIONS

This application claims priority to Japanese Patent Application No. 2018-216874 filed on Nov. 19, 2018, which is incorporated herein by reference in its entirety.

### BACKGROUND

### 1. Technical Field

The disclosure relates to an electric oil pump system and controlling method of an electric oil pump.

### 2. Description of Related Art

Japanese Unexamined Patent Application Publication No. 2000-230442 (JP 2000-230442 A) discloses that determination of degradation of an electric oil pump mounted in a vehicle is performed based on an accumulated driving time of the electric oil pump.

### SUMMARY

However, with the technique disclosed in JP 2000-230442 A, since the determination of degradation of the electric oil pump is performed based on the accumulated driving time of the electric oil pump from the past to the present, it is difficult to detect early a failure of the electric oil pump to be caused by its degradation, that is likely to occur in the future.

The disclosure provides an electric oil pump system and a controlling method of an electric oil pump that can detect early a failure of an electric oil pump to be caused by its degradation, that is likely to occur in the future.

A first aspect of the disclosure relates to an electric oil pump system including an electric oil pump and an electronic control unit. The electronic control unit is configured to: (I) accumulate driving time of the electric oil pump, (ii) predict driving time of the electric oil pump that occurs in the future, and (iii) determine degradation of the electric oil pump by taking into account an accumulated driving time and a predicted driving time. Here, the accumulated driving time is a driving time of the electric oil pump which the electronic control unit accumulates, and the predicted driving time is a driving time of the electric oil pump which the electronic control unit predicts.

In the above-described first aspect, the electric oil pump may include a motor and an oil pump. The motor may be configured to generate a driving force of the oil pump. The oil pump may include a rotor configured to be rotated by the driving force of the motor and be configured to pump oil by the rotor.

In the above-described first aspect, the electronic control unit is configured to predict the predicted driving time from a distance from a current location to a destination of a vehicle which is mounted with the electric oil pump and a speed of the vehicle.

In the above-described first aspect, the electric oil pump system may further include a notification device configured to notify a user of the degradation of the electric oil pump when the electronic control unit determines that the electric oil pump is degraded.

With the first aspect and the configuration thereof described above, it is possible to notify the user of the degradation of the electric oil pump and thus to prevent a failure of the electric oil pump.

In the above-described first aspect, the electric oil pump system may include a communication terminal, a server configured to communicate with the communication terminal, and a notification device. The notification device may be configured to perform notification of the degradation of the electric oil pump to a user via the communication terminal when the electronic control unit determines that the electric oil pump is degraded by taking into account the accumulated driving time and the predicted driving time.

With the configuration described above, it is possible to perform determination of the degradation of the electric oil pump according to a driving pattern of a user and to notify the user of the degradation of the electric oil pump, thus making it possible to prevent a failure of the electric oil pump.

In the above-described first aspect, the electronic control unit may be configured to determine that the electric oil pump is degraded, when at least one of the accumulated driving time or the predicted driving time is equal to or greater than a predetermined time.

With the configuration described above, it is possible to determine, early, the degradation of the electric oil pump.

In the above-described configuration, the electronic control unit may be configured to determine that the electric oil pump is degraded, when the accumulated driving time is less than a life of at least one of a plurality of components included in the electric oil pump and the predicted driving time is equal to or greater than the life of at least one of the plurality of components.

With the configuration described above, before the accumulated driving time of the electric oil pump exceeds the life of one of the plurality of components of the electric oil pump, it is possible to prevent a failure of the electric oil pump to be caused by its degradation, that is likely to occur in the future.

A second aspect of the disclosure relates to an electric oil pump system including an electric oil pump, and an electronic control unit, a communication terminal and a server. The electronic control unit is configured to: (iv) accumulate driving time of the electric oil pump, (v) predict driving time of the electric oil pump that occurs in the future. The server is configured to communicate with the communication terminal. And the server is configured to determine that the electric oil pump is degraded by taking into account an accumulated driving time and a predicted driving time. Here, the accumulated driving time is a driving time of the electric oil pump which is accumulated, and the predicted driving time is a driving time of the electric oil pump which is predicted.

In the above-described second aspect, the electronic control unit may be configured to predict the predicted driving time based on a distance from a current location to a destination of a vehicle which is mounted with the electric oil pump and a speed of the vehicle

With the second aspect and the configuration thereof described above, it is possible to determine, early, the degradation of the electric oil pump.

A third aspect of the disclosure relates to a controlling method of an electric oil pump. In the method, (iv) driving time of the electric oil pump is accumulated, (v) driving time of the electric oil pump that occurs in the future is predicted; and (vi) it is determined that the electric oil pump is degraded by taking into account an accumulated driving time and a predicted driving time, the accumulated driving time being a driving time of the electric oil pump which is accumulated, and the predicted driving time being a driving time of the electric oil pump which is predicted.

An electric oil pump system and a controlling method of the electric oil pump according to the disclosure exhibit an effect that, by performing determination of degradation of an electric oil pump by taking into account an accumulated driving time and a predicted driving time of the electric oil pump, it is possible to detect early a failure of the electric oil pump to be caused by its degradation, that is likely to occur in the future.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating the overall configuration of a vehicle equipped with an electric oil pump of an electric oil pump system according to a first and a second embodiments;

FIG. 2 is a block diagram illustrating the configurations of the vehicle equipped with the electric oil pump and a vehicle external facility;

FIG. 3 is a flowchart illustrating a first example of control that is performed in the electric oil pump system according to the first embodiment;

FIG. 4 is a flowchart illustrating a second example of control that is performed in the electric oil pump system according to the first embodiment; and

FIG. 5 is an enlarged figure of the electric oil pump shown in FIG. 1.

### DETAILED DESCRIPTION OF EMBODIMENTS

Hereinafter, an embodiment of an electric oil pump system according to the disclosure will be described. The disclosure is not limited to the embodiment.

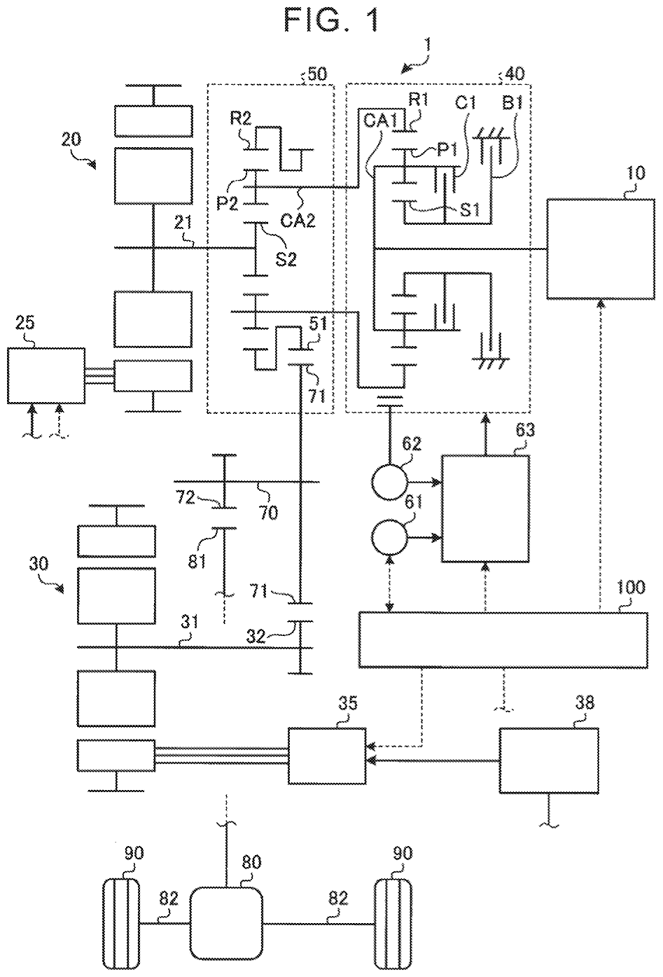

FIG. 1 is a diagram illustrating the overall configuration of a vehicle 1 equipped with the electric oil pump system according to the first and the second embodiments. The vehicle 1 includes a driving device and an electronic control unit 100 configured to control the driving device. The driving device includes an engine 10, a first electric rotary machine 20, a second electric rotary machine 30, a transmission 40, a differential device 50, a counter shaft 70, a differential gear unit 80, and drive wheels 90.

The vehicle 1 is a front-engine front-drive (FF) hybrid vehicle that can travel using at least one of power of the engine 10 and power of the second electric rotary machine 30. The drive system of the vehicle 1 is not limited to the FF system and may alternatively be the front-engine rear-drive (FR) system.

The engine 10 is, for example, an internal combustion engine such as a gasoline engine or a diesel engine. The first electric rotary machine 20 and the second electric rotary machine 30 are each, for example, a three-phase (U-phase, V-phase, W-phase) permanent magnet rotary machine including a rotor embedded with permanent magnets.

A rotary shaft 21 of the first electric rotary machine 20 is disposed coaxially with a crankshaft of the engine 10. A rotary shaft 31 of the second electric rotary machine 30 is disposed parallel to the rotary shaft 21 of the first electric rotary machine 20. A counter shaft 70 is disposed parallel to the rotary shaft 21 of the first electric rotary machine 20 and the rotary shaft 31 of the second electric rotary machine 30.

The first electric rotary machine 20 and the second electric rotary machine 30 are respectively driven by inverters 25, 35. The inverter 25 converts direct current power supplied from a battery 38 serving as an in-vehicle power storage device into three-phase alternating current power and supplies it to the first electric rotary machine 20. Likewise, the inverter 35 converts direct current power supplied from the battery 38 into three-phase alternating current power and supplies it to the second electric rotary machine 30. The second electric rotary machine 30 is also driven by electric power generated by the first electric rotary machine 20. The first electric rotary machine 20 is also driven by electric power generated by the second electric rotary machine 30.

The transmission 40 is provided between the engine 10 and the differential device 50. The transmission 40 changes the rotational speed from the engine 10 and outputs it to the differential device 50. The transmission 40 includes a single-pinion type planetary gear mechanism including a sun gear S1, pinions P1, a ring gear R1, and a carrier CA1, a clutch C1, and a brake B1.

The carrier CA1 is an input element to which the rotation of the engine 10 is input. The ring gear R1 is an output element that outputs the rotation of the engine 10 after the speed change to the differential device 50. The pinions P1 are disposed between the sun gear S1 and the ring gear R1 and meshing with the sun gear S1 and the ring gear R1. The pinions P1 are supported by the carrier CA1 such that each pinion P1 is rotatable both on its own axis and around the sun gear S1.

The clutch C1 is a hydraulic friction engagement element that can connect the sun gear S1 and the carrier CA1 to each other. When the clutch C1 is engaged, the sun gear S1 and the carrier CA1 are coupled together. When the clutch C1 is released, the sun gear S1 and the carrier CA1 are disconnected from each other. The brake B1 is a hydraulic friction engagement element that can inhibit the rotation of the sun gear S1. When the brake B1 is engaged, the sun gear S1 is fixed to a gear case so that the rotation of the sun gear S1 is inhibited. When the brake B1 is released, the sun gear S1 is disconnected from the gear case so that the rotation of the sun gear S1 is allowed. By engaging either one of the clutch C1 and the brake B1 and releasing the other, the transmission 40 is in a power transmitting state in which power is transmitted between the carrier CA1 serving as the input element and the ring gear R1 serving as the output element. On the other hand, by releasing the clutch C1 and releasing the brake B1, the transmission 40 is in a power cut-off state in which power is not transmitted between the carrier CA1 serving as the input element and the ring gear R1 serving as the output element.

The differential device 50 is a single-pinion type planetary gear mechanism including a sun gear S2, pinions P2, a ring gear R2, and a carrier CA2. The carrier CA2 of the differential device 50 is coupled to the ring gear R1 serving as the output element of the transmission 40 and rotates integrally with the ring gear R1. The pinions P2 are disposed between the sun gear S2 and the ring gear R2 and meshing with the sun gear S2 and the ring gear R2. The pinions P2 are supported by the carrier CA2 such that each pinion P2 is rotatable both on its own axis and around the sun gear S2. The sun gear S2 is coupled to the rotary shaft 21 of the first electric rotary machine 20. A counter drive gear 51 is connected to the ring gear R2. The counter drive gear 51 rotates integrally with the ring gear R2 and serves as an output gear of the differential device 50.

The counter shaft 70 is provided with a driven gear 71 and a drive gear 72. The driven gear 71 is in mesh with the counter drive gear 51 of the differential device 50. Powers of the engine 10 and the first electric rotary machine 20 are transmitted to the counter shaft 70 through the counter drive gear 51 of the differential device 50. The transmission 40 and the differential device 50 are connected in series in the power transmission path from the engine 10 to the counter shaft 70. Therefore, the rotation of the engine 10 is transmitted to the counter shaft 70 after having been subjected to the speed change in the transmission 40 and the differential device 50. The driven gear 71 is also in mesh with a reduction gear 32 connected to the rotary shaft 31 of the second electric rotary machine 30. That is, power of the second electric rotary machine 30 is transmitted to the counter shaft 70 through the reduction gear 32. The drive gear 72 is in mesh with a differential ring gear 81 of the differential gear unit 80. The differential gear unit 80 is connected to the right and left drive wheels 90 through right and left drive shafts 82, respectively. That is, the rotation of the counter shaft 70 is transmitted to the right and left drive shafts 82 through the differential gear unit 80.

The vehicle 1 includes an electric oil pump 61, a mechanical oil pump 62, and a hydraulic circuit 63 as a configuration that supplies working oil (automatic transmission fluid (ATF)) of the transmission 40 to the transmission 40.

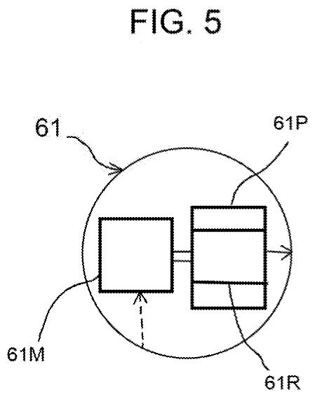

The electric oil pump 61 and the mechanical oil pump 62 suck working oil stored in an oil pan (not illustrated) and supply it to the hydraulic circuit 63. The electric oil pump 61 which is shown in FIG. 5 is composed of various components such as a motor 61M that generates a driving force and an oil pump 61P. The oil pump 61P includes a rotor 61R rotated by the driving force from the motor 61M and pumps working oil by the rotor 61R. The motor 61M of the electric oil pump 61 is connected to a power supply (not illustrated) and driven by electric power supplied from the power supply. The mechanical oil pump 62 is connected to the ring gear R1 of the transmission 40 and driven by power transmitted from the ring gear R1. The hydraulic circuit 63 includes a pressure control valve and solenoid valves. The pressure control valve adjusts the oil pressure of working oil supplied from at least one of the electric oil pumps 61 and the mechanical oil pump 62 to a constant line pressure. Using the line pressure as the source pressure, the solenoid valves adjust the oil pressure to be supplied to the clutch C1 of the transmission 40 and the oil pressure to be supplied to the brake B1 of the transmission 40.

Working oil not only functions as working oil of the transmission 40, but also is supplied to rotary members (rotary shafts, gears, bearings, etc.) in the driving device including the transmission 40, the differential device 50, the first electric rotary machine 20, the second electric rotary machine 30, and so on, so as to function as lubricating oil. Working oil further functions as cooling oil of the first electric rotary machine 20 and the second electric rotary machine 30. After circulating the inside of the driving device, working oil is returned to the oil pan.

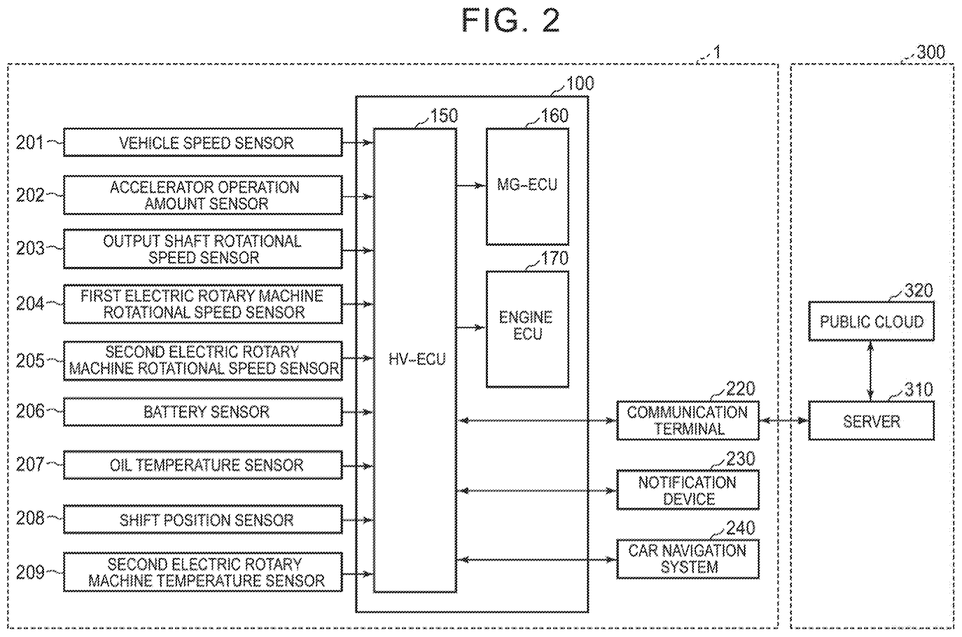

FIG. 2 is a block diagram illustrating the configurations of the vehicle 1 and a vehicle external facility 300. In the first and the second embodiments, the electronic control unit 100 is composed of, for example, an HV-ECU 150, an MG-ECU 160, and an ENGINE ECU 170. Each of the HV-ECU 150, the MG-ECU 160, and the ENGINE ECU 170 includes a computer. The number of ECUs is not limited to three and may be two or four or more. Alternatively, ECUs may be integrated into a single ECU as a whole.

The MG-ECU 160 controls the first electric rotary machine 20 and the second electric rotary machine 30. The MG-ECU 160 controls the output torque of the first electric rotary machine 20 by adjusting a current value to be supplied to the first electric rotary machine 20. Further, the MG-ECU 160 controls the output torque of the second electric rotary machine 30 by adjusting a current value to be supplied to the second electric rotary machine 30.

The ENGINE ECU 170 controls the engine 10. The ENGINE ECU 170 performs control of the opening degree of an electronic throttle valve of the engine 10, ignition control of the engine 10 by outputting an ignition signal, injection control of fuel to the engine 10, and so on. The ENGINE ECU 170 controls the output torque of the engine 10 by the opening degree control of the electronic throttle valve, the ignition control, the injection control, and so on.

The HV-ECU 150 performs integrated control of the entire vehicle 1. Various sensors such as a vehicle speed sensor 201, an accelerator operation amount sensor 202, an output shaft rotational speed sensor 203, a first electric rotary machine rotational speed sensor 204, a second electric rotary machine rotational speed sensor 205, a battery sensor 206, an oil temperature sensor 207, a shift position sensor 208, and a second electric rotary machine temperature sensor 209 are connected to the HV-ECU 150. From these sensors, the HV-ECU 150 acquires a vehicle speed, an accelerator operation amount, an output shaft rotational speed (rotational speed of the counter shaft 70), a rotational speed of the first electric rotary machine 20, a rotational speed of the second electric rotary machine 30, a current value, voltage value, and temperature of the battery 38, a temperature of working oil (ATF temperature), a shift position, a temperature of the second electric rotary machine 30, and so on.

The HV-ECU 150 calculates a state of charge (SOC) of the battery 38 based on at least one of the current values and the voltage value of the battery 38. Based on the temperature and the SOC of the battery 38, the HV-ECU 150 sets acceptable electric power of the battery 38. The acceptable electric power corresponds to an upper limit value of input electric power of the battery 38. The HV-ECU 150 controls the first electric rotary machine 20 and the second electric rotary machine 30 so that electric power to be input into the battery 38 does not exceed the acceptable electric power.

Based on the acquired information, the HV-ECU 150 calculates a demand value such as a demand driving force or demand driving torque for the vehicle 1. Based on the calculated demand value, the HV-ECU 150 determines torque of the first electric rotary machine 20, torque of the second electric rotary machine 30, and output torque of the engine 10. Then, the HV-ECU 150 outputs a command value of the torque of the first electric rotary machine 20 and a command value of the torque of the second electric rotary machine 30 to the MG-ECU 160. Further, the HV-ECU 150 outputs a command value of the engine torque to the ENGINE ECU 170.

The HV-ECU 150 controls the clutch C1 and the brake B1 of the transmission 40 according to a traveling mode and so on of the vehicle 1. The HV-ECU 150 outputs a command value of oil pressure to be supplied to the clutch C1 and a command value of oil pressure to be supplied to the brake B1 to the solenoid valves of the hydraulic circuit 63 (see FIG. 1), respectively.

The HV-ECU 150 can input and output various information from and to a communication terminal 220 provided in the vehicle 1. The communication terminal 220 can communicate with a server 310 provided in the vehicle external facility 300. For example, the server 310 is provided in a customer center of the vehicle 1 and stores information about a travel history and travel state (information about driving pattern of a user) of the vehicle 1 transmitted from the communication terminal 220, and so on. The server 310 can input and output various information from and to a public cloud 320. For example, the server 310 can acquire information about a travel history and travel state by a user of another vehicle of the same model as the vehicle 1, and so on.

The HV-ECU 150 can input and output various information from and to a notification device 230 provided in the vehicle 1. For example, the notification device 230 can notify the user using a display, a warning light, or the like provided in the vehicle cabin. Further, the HV-ECU 150 can input and output various information from and to a car navigation system 240 provided in the vehicle 1.

In the first and the second embodiments, the electric oil pump system is constituted by the electric oil pump 61, the HV-ECU 150, the communication terminal 220, the notification device 230, the car navigation system 240, the server 310, and so on.

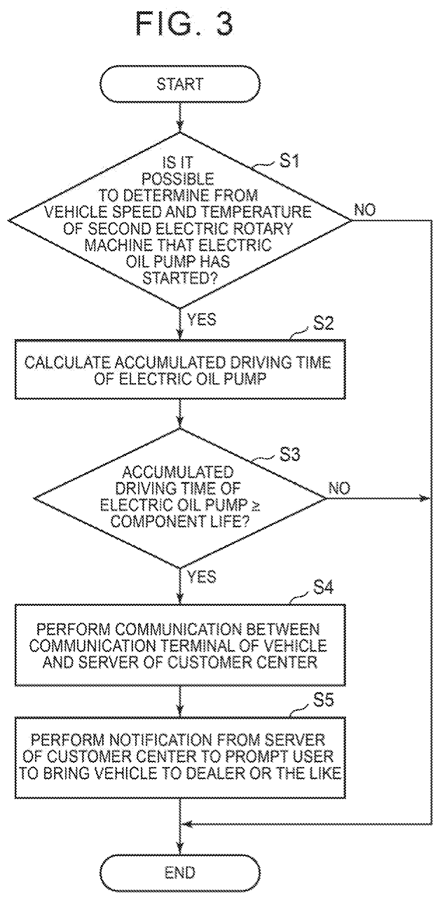

FIG. 3 is a flowchart illustrating a first example of control that is performed in the electric oil pump system according to the first embodiment. In this control, the HV-ECU 150 included in the electronic control unit 100 has functions to perform accumulation, prediction, and determination. The HV-ECU 150 accumulates driving time of the electric oil pump 61. The HV-ECU 150 predicts driving time of the electric oil pump 61 that will occur in the future. The HV-ECU 150 determines degradation of the electric oil pump 61 by taking into account an accumulated driving time and a predicted driving time. The accumulated driving time is the driving time accumulated of the electric oil pump 61, and the predicted driving time is the driving time predicted of electric oil pump 61. The HV-ECU 150, for example, calculates the predicted driving time based on a distance from a current location to a destination of a vehicle 1 which is mounted with the electric oil pump 61 and a speed of the vehicle 1.

First, based on the vehicle speed and the temperature of the second electric rotary machine 30, the HV-ECU 150 determines whether or not the electric oil pump 61 has started (step S1). The ATF temperature may alternatively be used in determining whether or not the electric oil pump 61 has started. When it is determined that the electric oil pump 61 has not started (No at step S1), the HV-ECU 150 ends a series of control steps. On the other hand, when it is determined that the electric oil pump 61 has started (Yes at step S1), the HV-ECU 150 calculates an accumulated driving time of the electric oil pump 61 (step S2). In this event, in the case where the motor 61M of the electric oil pump 61 is controlled by pulse width modulation (PWM) so that current supplied to the motor 61M has pulses with variable duty cycle to drive the motor 61M intermittently in a time period in which the electric oil pump 61 is driven, the accumulated driving time of the electric oil pump 61 may be calculated by “current value×driving time”.

Then, the HV-ECU 150 determines whether or not the accumulated driving time of the electric oil pump 61 is equal to or greater than the life of the components of the electric oil pump 61 (step S3). When it is determined that the accumulated driving time of the electric oil pump 61 is less than the component life (No at step S3), the HV-ECU 150 ends a series of control steps. On the other hand, when it is determined that the accumulated driving time of the electric oil pump 61 is equal to or greater than the component life (Yes at step S3), the HV-ECU 150 performs communication between the communication terminal 220 of the vehicle 1 and the server 310 of the customer center and transmits to the server 310 the determination result that the accumulated driving time of the electric oil pump 61 of the vehicle 1 is equal to or greater than the component life (step S4). Thereafter, notification to prompt the user to bring the vehicle 1 to a dealer or the like is performed from the server 310 of the customer center (step S5). For example, this notification is performed as follows. Specifically, communication is performed between the server 310 and the communication terminal 220 so that the notification is performed by the notification device 230 via the communication terminal 220 and the HV-ECU 150. In this way, taking into account the accumulated driving time of the electric oil pump 61, notification is performed to prompt the user to bring the vehicle 1 to a dealer or the like due to the degradation of the electric oil pump 61, so that it is possible to replace the components of the electric oil pump 61 before the occurrence of a failure of the electric oil pump 61.

After the components of the electric oil pump 61 are replaced, the HV-ECU 150 resets the accumulated driving time of the electric oil pump 61 and restarts counting up the driving time of the electric oil pump 61.

Further, in first embodiment, when the vehicle 1 travels by setting a destination in the car navigation system 240 installed in the vehicle 1, it is possible to not only determine the degradation of the electric oil pump 61 from the accumulated driving time as described above, but also determine, early, the degradation of the electric oil pump 61 that is likely to occur in the future. For example, in the case where, in long-distance travel of the vehicle 1 using the car navigation system 240, the accumulated driving time of the electric oil pump 61 is less than the component life at a departure location so that the degradation of the electric oil pump 61 is not determined, it is possible to determine the degradation of the electric oil pump 61, of which the accumulated driving time becomes equal to or greater than the component life before reaching a destination, before the vehicle 1 starts from the departure location.

Specifically, in the first embodiment, it is possible to determine the degradation of the electric oil pump 61 by taking into account an accumulated driving time being the driving time, accumulated, of the electric oil pump 61 and a predicted driving time being the driving time of the electric oil pump 61 that will occur in the future. For example, the predicted driving time of the electric oil pump 61 can be predicted by a predicted driving time of the vehicle 1 from a current location to a destination that is acquired from the car navigation system 240, and so on.

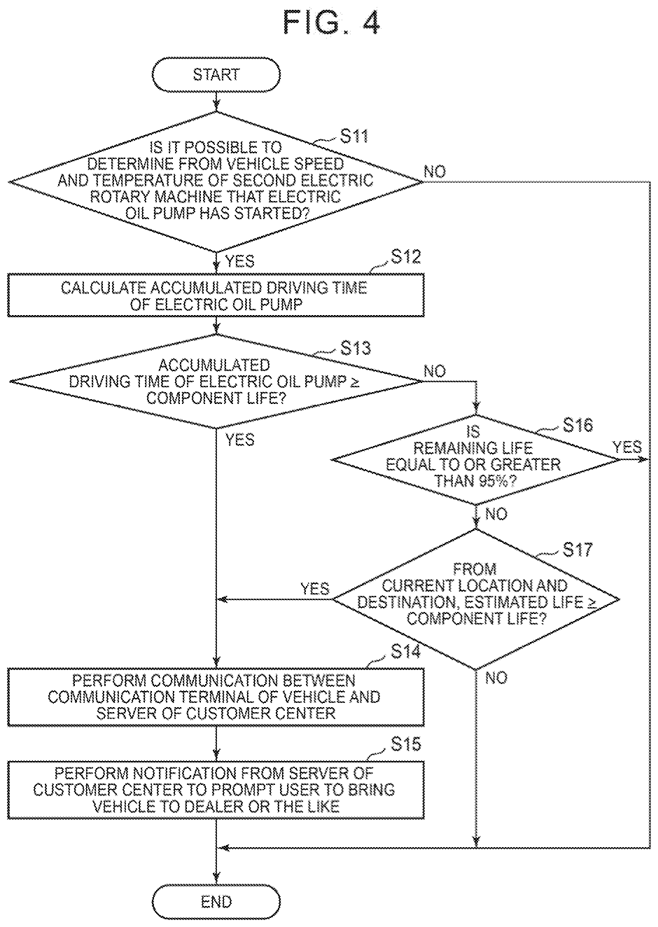

FIG. 4 is a flowchart illustrating a second example of control that is performed in the electric oil pump system according to the first embodiment. In this control, the HV-ECU 150 has functions to perform accumulation, prediction, and determination. The HV-ECU 150 accumulates driving time of the electric oil pump 61. The HV-ECU 150 predicts driving time of the electric oil pump 61 that will occur in the future. The HV-ECU 150 determines the degradation of the electric oil pump 61 by taking into account an accumulated driving time being the driving time accumulated and a predicted driving time being the driving time predicted.

First, based on the vehicle speed and the temperature of the second electric rotary machine 30, the HV-ECU 150 determines whether or not the electric oil pump 61 has started (step S11). When it is determined that the electric oil pump 61 has not started (No at step S11), the HV-ECU 150 ends a series of control steps. On the other hand, when it is determined that the electric oil pump 61 has started (Yes at step S11), the HV-ECU 150 calculates an accumulated driving time of the electric oil pump 61 (step S12). Then, the HV-ECU 150 determines whether or not the accumulated driving time of the electric oil pump 61 is equal to or greater than the life of the components of the electric oil pump 61 (step S13). When it is determined that the accumulated driving time of the electric oil pump 61 is less than the component life (No at step S13), the HV-ECU 150 determines whether or not the remaining life of the components of the electric oil pump 61 is equal to or greater than 95% (step S16). The remaining life used at step S16 is set to 100% when the components of the electric oil pump 61 are new. Herein, the remaining life is not necessarily limited to 95% or greater. For example, the remaining life may be set to a value such as 85% or greater or 90% or greater as appropriate.

When it is determined at step S16 that the remaining life is equal to or greater than 95% (Yes at step S16), the HV-ECU 150 ends a series of control steps. On the other hand, when it is determined at step S16 that the remaining life is less than 95% (No at step S16), the HV-ECU 150 determines from a current location and a destination whether or not the estimated life of the components of the electric oil pump 61 at a time point when the vehicle 1 reaches the destination is equal to or greater than the component life (step S17). This estimated life can be calculated, for example, using a predicted driving time of the electric oil pump 61 from the current location of the vehicle 1 to its destination. When it is determined that the estimated life is less than the component life (No at step S17), the HV-ECU 150 ends a series of control steps.

On the other hand, when the HV-ECU 150 has determined at step S13 that the accumulated driving time of the electric oil pump 61 is equal to or greater than the component life (Yes at step S13), or when the HV-ECU 150 has determined at step S17 that the estimated life is equal to or greater than the component life (Yes at step S17), the HV-ECU 150 performs communication between the communication terminal 220 of the vehicle 1 and the server 310 of the customer center and transmits to the server 310 the determination result that the accumulated driving time of the electric oil pump 61 of the vehicle 1 is equal to or greater than the component life, or the determination result that the estimated life is equal to or greater than the component life (step S14). Thereafter, notification to prompt the user to bring the vehicle 1 to a dealer or the like is performed from the server 310 of the customer center (step S15). For example, as described above, this notification is performed as follows. Specifically, communication is performed between the server 310 and the communication terminal 220 so that the notification is performed by the notification device 230 via the communication terminal 220 and the HV-ECU 150.

In this way, taking into account the accumulated driving time and predicted driving time of the electric oil pump 61, notification is performed to prompt the user to bring the vehicle 1 to a dealer or the like due to the degradation of the electric oil pump 61 before the accumulated driving time of the electric oil pump 61 exceeds the life of the components of the electric oil pump 61, so that it is possible to replace the components of the electric oil pump 61 before the occurrence of a failure of the electric oil pump 61.

After the components of the electric oil pump 61 are replaced, the HV-ECU 150 resets the accumulated driving time of the electric oil pump 61 and restarts counting up the driving time of the electric oil pump 61.

The remaining life of the components of the electric oil pump 61 differs depending on a driving pattern of the user of the vehicle 1 and so on. Therefore, the server 310 may be configured to determine the degradation of the electric oil pump 61, and when the server 310 determines the degradation of the electric oil pump 61, first, information about accumulated driving time and predicted driving time of the electric oil pump 61 may be transmitted from the communication terminal 220 of the vehicle 1 to the server 310 of the customer center. Then, hereinafter, an electric oil pump system according to the second embodiment is explained. The electric oil pump system of the second embodiment includes the electric oil pump 61, the electronic control unit 100, the communication terminal 220 and the server 310. The electronic control unit 100 is configured to accumulate driving time of the electric oil pump 61 and to predict driving time of the electric oil pump 61 that will occur in the future. The server 310 determines degradation of the electric oil pump 61. That is, the server 310 is configured to determine degradation of the electric oil pump 61 by taking into an accumulated driving time and a predicted driving time. The accumulated driving time is the driving time accumulated of the electric oil pump 61, and the predicted driving time is the driving time predicted of the electric oil pump 61. Then, the server 310 performs the determination of degradation of the electric oil pump 61 based on the accumulated driving time, the predicted driving time of the electric oil pump 61 and information about a travel history and travel state (information about driving pattern of the user) of the vehicle 1 stored in the server 310. Then, when the determination of the degradation of the electric oil pump 61 is performed by the server 310, notification from the server 310 to prompt the user to bring the vehicle 1 to a dealer or the like is performed using the notification device 230 as described above.

Consequently, with the electric oil pump system according to the first embodiment or the second embodiment, the server 310, taking into account the accumulated driving time and predicted driving time of the electric oil pump 61, performs determination of degradation of the electric oil pump 61 according to the driving pattern of the user of the vehicle 1, so that it is possible to detect early a failure of the electric oil pump 61 that is likely to occur in the future, and notify the user accordingly, thus making it possible to prevent a failure of the electric oil pump 61.

What is claimed is:

1. An electric oil pump system comprising:
an electric oil pump; and
an electronic control unit, the electronic control unit being configured to,
accumulate driving time of the electric oil pump,
predict driving time of the electric oil pump that occurs in the future, and
determine degradation of the electric oil pump by taking into account an accumulated driving time and a predicted driving time, the accumulated driving time being a driving time of the electric oil pump which the electronic control unit accumulates, and the predicted driving time being a driving time of the electric oil pump which the electronic control unit predicts.

2. The electric oil pump system according to claim 1, wherein the electric oil pump includes a motor and an oil pump, the motor being configured to generate a driving force of the oil pump, the oil pump including a rotor configured to be rotated by the driving force of the motor and being configured to pump oil by the rotor.

3. The electric oil pump system according to claim 1, wherein the electronic control unit is configured to predict the predicted driving time based on a distance from a current location to a destination of a vehicle which is mounted with the electric oil pump and a speed of the vehicle.

4. The electric oil pump system according to claim 1, further comprising a notification device configured to notify a user of the degradation of the electric oil pump when the electronic control unit determines that the electric oil pump is degraded.

5. The electric oil pump system according to claim 1, further comprising:
a communication terminal;
a server configured to communicate with the communication terminal; and
a notification device configured to perform notification of the degradation of the electric oil pump to a user via the communication terminal, when the electronic control unit determines that the electric oil pump is degraded by taking into account the accumulated driving time and the predicted driving time.

6. The electric oil pump system according to claim 1, wherein the electronic control unit is configured to determine that the electric oil pump is degraded, when at least one of the accumulated driving time or the predicted driving time is equal to or greater than a predetermined time.

7. The electric oil pump system according to claim 6, wherein the electronic control unit is configured to determine that the electric oil pump is degraded, when the accumulated driving time is less than a life of at least one of a plurality of components included in the electric oil pump and the predicted driving time is equal to or greater than the life of at least one of the plurality of components.

8. An electric oil pump system comprising:
an electric oil pump;
an electronic control unit, the electronic control unit being configured to,
accumulate driving time of the electric oil pump,
predict driving time of the electric oil pump that occurs in the future; and
a communication terminal; and
a server configured to communicate with the communication terminal and configured to determine that the electric oil pump is degraded by taking into account an accumulated driving time and a predicted driving time, the accumulated driving time being a driving time of the electric oil pump which is accumulated, and the predicted driving time being a driving time of the electric oil pump which is predicted.

9. The electric oil pump system according to claim 8, wherein the electronic control unit is configured to predict the predicted driving time based on a distance from a current location to a destination of a vehicle which is mounted with the electric oil pump and a speed of the vehicle.

10. A controlling method of an electric oil pump comprising:
accumulating driving time of the electric oil pump;
predicting driving time of the electric oil pump that occurs in the future; and
determining that the electric oil pump is degraded by taking into account an accumulated driving time and a predicted driving time, the accumulated driving time being a driving time of the electric oil pump which is accumulated, and the predicted driving time being a driving time of the electric oil pump which is predicted.
